(19) United States
(12) Patent Application Publication
(10) Pub. No.: US 2026/0031624 A1
(43) Pub. Date: Jan. 29, 2026

(54) SYSTEM AND METHODS FOR ALLOCATING POWER TO LOADS BASED ON LOAD CLASSIFICATIONS

(71) Applicant: BluWave Inc., Ottawa (CA)

(72) Inventors: Thomas TRIPLET, Ottawa (CA); Owen KELLY, Ottawa (CA); Kevin SHIMOTAKAHARA, Ottawa (CA)

(21) Appl. No.: 18/763,391

(22) Filed: Jul. 26, 2024

(51) Int. Cl. H02J 3/12

(52) U.S. Cl. CPC H02J 3/12; H02J 2203/10; H02J 2310/52; H02J 2310/58

(57) ABSTRACT

Systems and methods are provided for allocating and providing power to electric loads based on load classification information. A power system, such as a local electrical utility, may receive load demand requests from customers or loads wanting to consume power, and the system may allocate power to the loads based on load classifications of each of the loads. The system may then communicate the power allocations to the loads, and the loads may then consume power based on the power allocated to each of the loads. These improvements may be used to, for example, reduce the likelihood or frequency of demand response events in which power demand exceeds supply since the system may limit the total amount of power that is allocated at any given time.

### FIELD

The present disclosure relates to allocating power to electric loads, including allocating power based on classifications of loads.

### BACKGROUND

Existing power distribution systems can meter the total aggregate power consumption of residential and commercial customers using simple or smart meters installed at the point of ingress to the serviced building or facility. Users of power in the serviced building or facility are typically billed on a monthly basis as a function of their electricity consumption, peak demand, and other service charges. Using this model, all electric loads on a circuit are treated equally as measured by the smart meter and from a billing perspective. Users can purchase consumer products for personal measurement of individual power consumption in real time, such as current transformer (CT) meters that can be used to measure the power consumption of a particular circuit.

As a result of aggregate load power consumption and billing, responding to predicted and/or active demand response events can be subject to challenges. Such challenges may be scalability challenges, for example, managing the back-and-forth communication between utilities (and/or utility providers) and electricity consumers to negotiate reductions in power consumption during the demand response event. Utilities may negotiate the reductions in power consumption with multiple consumers at a time to determine a solution to power curtailment that meets the curtailments needs while also obtaining agreement from the electricity consumers to curtail their power. This negotiation process can be iterative and time consuming. During a demand response event, inefficiencies and/or outages may occur due to the effects of the demand response event until the utility and consumers reach a solution regarding reduced energy consumption.

Demand response events can also depend on load forecasts. Utilities may use load forecasts to anticipate when the distribution network may be overloaded so they can request electricity consumers to defer and/or reduce their load(s) before the potential demand response event occurs. This response to predicted demand response events can introduce additional complexity, for example, due to the uncertainties, variability, or errors in forecasts or uncertainties or variability in consumer behaviour with respect to electricity consumption.

Devices, systems, and methods offering differentiated power servicing schemes based on load type are desired.

The above information is presented as background information only to assist with an understanding of the present disclosure. No assertion or admission is made as to whether any of the above, or anything else in the present disclosure, unless explicitly stated, might be applicable as prior art with regard to the present disclosure.

### BRIEF DESCRIPTION OF DRAWINGS

Example embodiments of the present disclosure will now be described with reference to the attached Figures.

FIG. 1A is a diagram of an example embodiment of a power allocation system for allocating power from a power system, such as a power grid, to a plurality of electric loads.

FIG. 1B is a block diagram representing some example features and components of the system of FIG. 1A.

FIG. 2 is a diagram showing example load classifications in an example tree or hierarchy structure.

FIG. 3 is a message sequence diagram showing an example embodiment of allocating power allocation based on load classification information and load profile information.

FIG. 4 shows an example of a power resources secondary market grid and associated graph related to a secondary market for buying and selling allocated power resources.

FIG. 5 is a process flow diagram of an example method.

FIG. 6 is a block diagram of an example computerized device or system according to an embodiment.

The relative sizes and relative positions of elements in the drawings are not necessarily drawn to scale. For example, the shapes of various elements and angles are not necessarily drawn to scale, and some of these elements may be arbitrarily enlarged and/or positioned to improve the readability of the drawings. Further, the particular shapes of the elements as drawn are not necessarily intended to convey any information regarding the actual shape of the particular elements, and have been solely selected for ease of recognition in the drawings.

### DETAILED DESCRIPTION

This disclosure generally relates to allocating power to electric loads, including allocating power based on classifications of loads.

Thus, the present disclosure provides improvements in the fields of power management technologies, including power demand and consumption management technologies.

According to an aspect, the present disclosure involves a concept of load classifications, which provides a basis for discriminating between different classifications of loads that consume power from a power system such as an electric utility or power grid. Various types of loads may each be assigned to a particular load classification based on one or more factors relating to the load, for example the function of the load, the owner of the load, the location of the load, whether the load is residential or commercial, and so on.

According to the present disclosure, a system may allocate power in a centralized fashion to various loads in the system on the basis of the classifications of each load, where different classifications may be treated differently for the purpose of allocating power. For example, if power demand is predicted to exceed power supply, then the system may allocate power strategically to loads in certain types of load classifications before allocating power to loads on other types of classifications. A mere example is prioritizing the allocating of power to loads used for home and building heating and cooling over less important loads such as heaters for swimming pools and hot tubs. This type of system may be used by power providers, such as electrical utility companies, to provide new control over power consumption. The control may be used to reduce the likelihood or frequency of demand response events where power demand exceeds supply since many loads will be allocated power in a strategic way.

An allocation system may comprise a resource allocator, which may receive power demand requests associated with various loads in a grid. The loads may each be assigned a load classification. The loads may be smart loads or may be otherwise be in communication with a smart device such as a computer. The resource allocator allocates power to the various loads at least partly based on the classifications of each of the loads. The allocation of power may be done for predetermined periods of time into the future, for example time slots going forward. At a future time, the resource allocator may perform another allocation of power for a subsequent time slot and based on the current power demand requests from loads and possibly on other current information or data.

Once loads have been allocated power for one or more time slots, a load may consume the power that it has been allocated. However, in some embodiments, it may be possible for a load to not comply with its allocation and instead to consume power in any manner. For example, a dishwasher may send a request for power after a user presses a button to start a wash cycle. The resource allocator may not allocate power to the dishwasher right away but instead may provide a deferred power allocation when there is less power demand in the system, for instance over night. However, a user of the dishwasher may select to not comply with allocation and instead to start the dishwasher immediately. Furthermore, in some embodiments, the compliance with power allocations may be enforced. For instance, a load may only be able to consume power after having been granted an authorization to consume power in the manner allocated to it. For example, a system may be configured such that a dishwasher is only able to consume power during a specific time window and may not exceed a predefined limit on consumed power, for example electrical current.

The present disclosure provides improvements relating to power demand response and management by managing electricity demand through a centralized resource allocation that may process electricity consumption requests, for example in a particular region of an electricity distribution network. For instance, consumers (or loads of consumer) request electricity consumption permits for a particular window of time. The allocator then allocates power to the various loads based on the requests and load classifications. This is a departure from the conventional reactive top-down demand response event approach where a power utility is in search of demand side reductions.

The improvements according to the present disclosure approach may improve the scalability and efficacy of demand side management in power systems. In addition, the ability to proactively reduce or cap the consumption of power in a system may reduce or eliminate a need to anticipate and address when demand response events will need to be issued since the system would rarely get overloaded in the first place.

According to an aspect, the present disclosure is directed to a system, comprising a computer-readable storage medium having executable instructions; and one or more computer processors configured to execute the instructions to provide control in relation to a power system for allocating power to a plurality of electric loads, the instructions to: receive load classification information, the load classification information including a load classification associated with each of the plurality of loads, wherein there are multiple different load classifications; receive load demand request information, the load demand request information including multiple load demand requests for power, wherein each request is associated with at least one load; allocate power to the loads based on the load classification information and on the load demand request information; and provide power allocation information to the loads, the power allocation information based on the allocated power.

In an embodiment, the instructions are further to provide power consumption authorization information to the loads, the power consumption authorization information based on the allocated power to the loads and granting permission to the loads to consume power as allocated to the loads.

In an embodiment, at least one load is assigned a higher power allocation priority relative to another load, and wherein the allocating power to the loads is also based on power allocation priority information assigned to at least some of the loads.

In an embodiment, at least some of the load demand requests are each associated with load profile information, wherein the load profile information relates to a nature of the request for power associated with the load demand request, and wherein the allocating power to the loads is also based on the load profile information.

In an embodiment, load profile information associated with a load demand request comprises information relating to power consumption shape, wherein power consumption shape relates to power level and temporal information.

In an embodiment, load profile information associated with a load demand request comprises information relating to load deferability, wherein load deferability relates to an availability for delaying in time consumption of the power associated with the load demand request.

In an embodiment, load profile information associated with a load demand request comprises information relating to load curtailability, wherein load curtailability relates to an availability for curtailment of the power associated with the load demand request.

In an embodiment, allocating power to the loads comprises allocating power to a load wherein the allocation to the load includes a power consumption shape limitation.

In an embodiment, the instructions are further to determine a level of compliance by a load to power that has been allocated to the load, and initiating a compliance action based on the determined level of compliance.

According to an aspect, the present disclosure is directed to a method comprising at one or more electronic devices each having one or more processors and computer-readable memory, to provide control in relation to a power system for allocating power to a plurality of electric loads: receiving load classification information, the load classification information including a load classification associated with each of the plurality of loads, wherein there are multiple different load classifications; receiving load demand request information, the load demand request information including multiple load demand requests for power, wherein each request is associated with at least one load; allocating power to the loads based on the load classification information and on the load demand request information; and providing power allocation information to the loads, the power allocation information based on the allocated power.

In an embodiment, a method further comprises providing power consumption authorization information to the loads, the power consumption authorization information based on the allocated power to the loads and granting permission to the loads to consume power as allocated to the loads.

In an embodiment, at least one load is assigned a higher power allocation priority relative to another load, and wherein the allocating power to the loads is also based on power allocation priority information assigned to at least some of the loads.

In an embodiment, at least some of the load demand requests are each associated with load profile information, wherein the load profile information relates to a nature of the request for power associated with the load demand request, and wherein the allocating power to the loads is also based on the load profile information.

In an embodiment, load profile information associated with a load demand request comprises information relating to power consumption shape, wherein power consumption shape relates to power level and temporal information.

In an embodiment, load profile information associated with a load demand request comprises information relating to load deferability, wherein load deferability relates to an availability for delaying in time consumption of the power associated with the load demand request.

In an embodiment, load profile information associated with a load demand request comprises information relating to load curtailability, wherein load curtailability relates to an availability for curtailment of the power associated with the load demand request.

In an embodiment, allocating power to the loads comprises allocating power to a load wherein the allocation to the load includes a power consumption shape limitation.

In an embodiment, a method further comprises determining a level of compliance by a load to power that has been allocated to the load, and initiating a compliance action based on the determined level of compliance.

According to an aspect, the present disclosure is directed to a non-transitory computer-readable medium comprising having computer-readable instructions stored thereon, the computer-readable instructions executable by at least one processor to cause the performance of operations relating to providing control in relation to a power system for allocating power to a plurality of electric loads, the operations comprising receiving load classification information, the load classification information including a load classification associated with each of the plurality of loads, wherein there are multiple different load classifications; receiving load demand request information, the load demand request information including multiple load demand requests for power, wherein each request is associated with at least one load; allocating power to the loads based on the load classification information and on the load demand request information; and providing power allocation information to the loads, the power allocation information based on the allocated power.

In an embodiment, the operations further comprise providing power consumption authorization information to the loads, the power consumption authorization information based on the allocated power to the loads and granting permission to the loads to consume power as allocated to the loads.

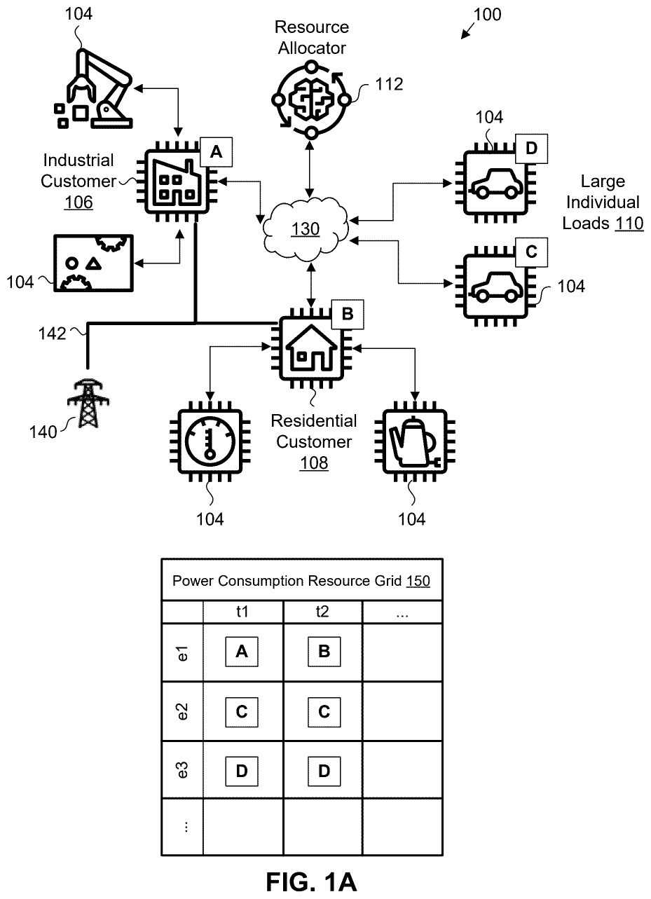

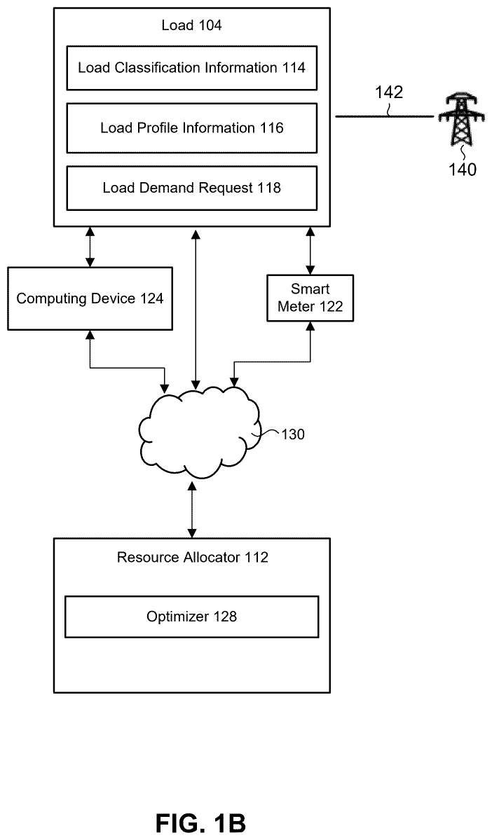

FIG. 1A is a diagram of an example embodiment of a power allocation system 100 for allocating power from a power system 140, such as a power grid, to a plurality of electric loads 104. System 100 may be based on a request-allocation scheme, in which loads make requests for power (or requests are made on behalf of loads) and the system in turn allocates power to loads 104 based on the requests. Allocating power to a load generally refers to assigning power to the load, which is separate from the load consuming power. Requests for power from loads 104 may be provided to a resource allocator 112. The power allocation may be performed by resource allocator 112 and the power allocation may be communicated otherwise provided to loads 104. The power allocation may be done in a strategic manner and may be based on the load classifications of the individual loads and potentially based on other factors or metrics as well. The allocation may be performed repeatedly at specific points in time, for example periodically according to a predefined schedule (for example every 10 minutes).

The arrows in FIG. 1A generally represent communication paths. FIG. 1A also shows some example power system infrastructure for delivering power from one or more power generation sources to the loads. For example, lines 142 from power system 140 to customers 106, 108 and thus to loads 104s may represent power transmission lines. The power system infrastructure may typically be existing power grid infrastructure, for example that of a local power utility, and so on.

A power system generally refers to any system that involves the transmission and/or distribution of power, including electrical power. A power system may include a power grid, which is generally a network for transmission and distribution from power producers to end customers. In addition, a power system may refer to only part of a power grid. However, in general, the terms power system and power grid are used interchangeably herein. Furthermore, a power grid generally refers to any power network or system, and is thus not limited to a conventional power grid.

A power allocation system according to the present disclosure may be used at any level in a power system, including at a power transmission level or a power distribution level. An example of a power distribution level is a local electrical utility company. In some embodiments, several power allocation systems may be employed, for example in a power grid or power distribution network, for instance to cover different parts or regions of those networks. As a mere example, a power allocation system may be employed at a substation level in a local power distribution network. Furthermore, a power allocation system may be used with only some of the loads in the power system, for example since some of the loads may not be configured to participate in a request-allocate scheme. For example, some loads may be “dumb”, passive and/or non-communicating loads, that is, they simply draw power as needed without any feedback mechanism, and thus may not be capable of initiating a request for power or receiving a power allocation. For simplicity, such loads will be referred to herein as dumb loads. In addition, some loads may have such capabilities but may be configured to not participate in a request-allocate scheme. Those loads lack interactive capabilities, which can lead to inefficiencies in power distribution systems.

A request for power is generally referred to as a load demand request, and may typically include information relating to an amount of power being requested and possibly also time related information, for example for how long the load wants to consume power. A simple example is a load demand request for an electric clothes dryer for 2400 W of power over a 1.0 hour time period.

A load demand request may include or be associated with load classification information about the load. Further, a load demand request may include any suitable information, for example load type, load consumption shape and/or timing, start time, end time, duration, and so on. A load demand request may include or be associated with load profile information relating to the load, the load classification, and/or the specific request for power. In some embodiments, some of this information may be stored in a database at or associated or accessible by the resource allocator.

One or more load classifications may be or have been assigned to a load in any suitable way. For example, in the case of a smart load, the load classifications or related information may be preprogrammed into the smart load. Load classification information of a load may be provided to resource allocator in a load demand request or in any other manner. Alternatively, a load classification may be assigned to a load in any other way. In addition, a load classification may be identified and assigned by a device inferentially based on an analysis of electrical power signals of the load, for example an electrical signal profile of the load, since different types of loads have different signal profiles (for example a profile of a stove is different than a profile of a washing machine). This may be done, for example, for a “dumb” load that is no able to store load classification information about itself. An inferential identification of load classification may be done by the system or in any other manner. An inferential identification of load classification may be done using machine learning methods to predict and classify a load into one or more load classifications.

Power allocation may also be based on load profile information of the various loads. A load and/or a load classification may be associated with a load profile, which generally includes information relating to the nature of a load, or to the nature of the power being requested by a load. A load profile may include information relating to the load such as load priority (for example so loads can have relative priorities for power allocation), load shape (for example typical or requested power consumption as a function of time), load deferability (for example degree to which consumption may be deferred in time), load curtailability (for example degree to which consumption may be curtailed, meaning reduced), and so on. Thus, a load classification may have an associated load profile for the types of loads within that classification. Further, individual loads may each have one or more associated load profiles. In addition, a specific load profile may be included with or otherwise associated with a load demand request for a load. For example, a dishwasher may submit a request with a load profile for a turbo wash, which may be a shorter wash at a high intensity, thereby consuming high power and high current. A load profile relating to the turbo mode may be included in a load demand request. Further, a dishwasher may submit a request with a load profile for an “eco” wash, which may be a longer wash at a lower intensity, thereby consuming less power and lower current. A load profile relating to the eco mode may be included in a load demand request. A resource allocator may treat these two load demand requests differently since they each indicate a different power request at least as indicated by the different respective load profiles.

The loads may be any types of electric loads 104 that consume power from a power system, for example an electrical utility, power grid, or any other power delivery system. Loads 104 may be industrial loads 106 from one or more industrial customers, residential loads 108 from one or more residential customers, and/or large individual loads 110. The large individual loads 110 may include one or more electric vehicles (EVs) or other large loads from one or more industrial and/or residential customers.

A load may be or comprise a smart device, which is generally an electronic device which is generally able to perform computing tasks and to communicate with other devices over communications links or networks. A smart device often includes computing hardware, which may be configured to perform computer processing and communications, and may also comprise input/output functionality which may include human-machine interface features. Furthermore, a load may be a “dumb” device. A load, such as a dumb load, may be controlled by another computing device. Such a computing device may be a smart plug which enables some form of control over the load. A smart plug may be connected to power, for example by being plugged into an electrical socket, and the load may be connected to the smart plug, for example by plugging the load into the smart plug. A smart plug generally provides control for turning a load on and off, but may also provide other functionality such as metering power used by a load, or scheduling the turning on and off of the load.

Generally, resource allocator 112 may communicate with each of loads 104 or any other devices in any suitable way, for example via a communication channel or link 130, which may comprise a communications network 130. A communication link may be wired or wireless. While communication link(s) 130 is illustrated as a communications network in the figures, this is merely an example and is not limiting. A communication network may be any suitable network or other communication means, for example a telecommunication network such as ethernet, long term evolution (LTE), WiFi, and so on, or power line communication (PLC). Further, communication between resource allocator 112 and a load 104 may be direct or may be indirect, for example via one or more computing devices, such as a computing device 124 or meter 122.

The term “power” is used to represent energy, for example in the form of electricity or any other suitable energy form for a given application, and measured in any suitable unit, such as energy, voltage, current, power, work, etc. While the present disclosure includes embodiments that relate to the allocation of electric power, this is not meant to be limiting. The present disclosure includes and applies to applications other than electric power, for example to other types of substances, materials, energies, and so on, including but not limited to natural gas, hydrogen gas, oil, water, and so on.

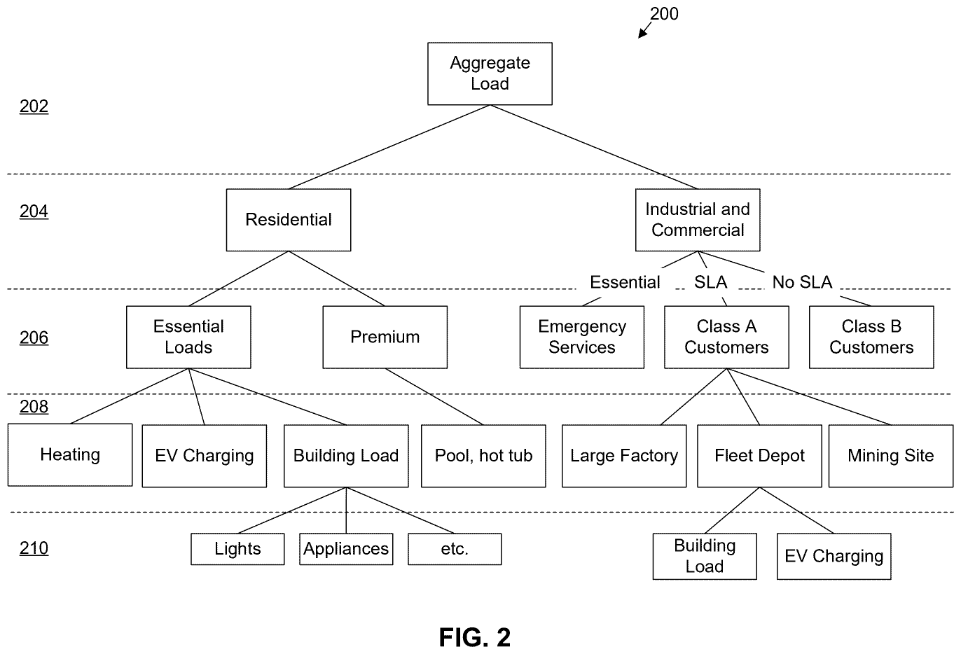

FIG. 1B is a block diagram representing some example features and components of system 100 of FIG. 1A. While FIG. 1B shows only one load 104, a system may have multiple and in some cases many loads 104. A load 104 may comprise or be associated with one or more of load classification information 114, load profile information 116, and load demand request information 118. At least some of loads 104 each have associated load classification information 114, which may comprise one or more load classifications, that may be used to differentiate different classifications or categories of loads by one or more various metrics such as load type, customer type, power requirements. For example, a refrigerator may be assigned a classification of “refrigerator” or “refrigerator/freezer”. Some loads may be assigned multiple classifications. FIG. 2 provides some further examples of load classification information 114 and various example load classifications. Load profile information 116 may generally comprise metadata that characterizes a nature of a load demand request to be provided to a resource allocator. Load profile information 116 may comprise information relating to how a given load may consume power or to other information relating to the load, such as different operation modes, timing, geographic location, and so on. In at least some embodiments, load profiles are associated with both load classifications and particular load devices. Load classifications may define a metadata structure of a load profile, for example what metadata will be present within (which is an instance of a load class) a load profile of particular device. A particular device may be considered to be an instance of a load classification class.

Resource allocator 112 may receive load classification information 114 associated with at least some of the loads 104, for example from one or more of loads 104, computing devices 124 associated with loads 104 or customers, a smart meter 122 or other device of a customer, a database, a memory, or anywhere else. The database or memory may be a local database or memory of the resource allocator or an external database or memory. Computing device 124 may be a computing device associated with a user associated with the load, for example a smart phone, tablet, or any other computing device. Computing device 124 may be a smart device, such as a smart plug. Computing device 124 may communicate with load 104 and/or resource allocator 112. Computing device 124 may be configured to communicate with smart meter 122, for example to at least receive information from power meter 122. Smart meter 122 may generally be able to measure or meter parameters relating to power to which the meter is coupled. Smart meter 122 may be any suitable type of meter for metering electricity and may be able to communicate information including metering data with other devices such as load 104, resource allocator 112, computing device 124, and so on.

In addition to load classification information 114 and potentially load profile information 116, the allocating of power to loads 104 may also be based on other information, for example historical information, real-time information, and/or predicted information. These types of information may relate to suitable types of information, for example information about the power system such as state information of the power system including power factor, frequency, infrastructure power servicing capacities; levels and types of power generation; power distribution; power management; season/time of day; weather data, public event, schedules and emergency notifications; and/or power consumption.

In some embodiments, the system may comprise one or more predictors. For example, a predictor may be used to predict power demand in the system. Predictions of power demand may be used by the resource allocator to generate power allocations to loads. For example, if demand is low or is predicted to be low, or supply is high or is predicted to be high, then the resource allocator may allocate more power for a given time period. Similarly, if demand is high or is predicted to be high, then the resource allocator may allocate less power for a given time period.

In some embodiments, load classification information 114 or load profile information 116 may be used to contribute to the accuracy or specificity of a predictor, for example a power demand predictor. For example, load classification information 114 or load profile information 116 may be used as inputs to a predictor. For example, historical and/or real-time information may include information relating to numbers, types, and/or timing of load demand requests for a given time period. For instance, historical information may include data indicating that on average, on Tuesdays in the month of May, there are on average a specific number of load demand requests, the breakdown of load demand requests from various load classifications, the timing of the requests, information about the power requested for the loads (such as amount of power, timing, load profile information), and so on. Furthermore, historical information may include any other types of suitable information, for example relating to power supply, power demand, weather, traffic, and so on. Other types of information used by resource allocator 112 may include any types of constraint information, for example constraints of the power system or power grid such as amounts or types of power available, constraints imposed by user inputs, and so on.

Thus, inputs to resource allocator 112 for performing power allocation may include one or more of the following, namely load demand request information, load classification information, load profile information, other information such as historical information, real-time information, prediction information, and so on. Input may be received or obtained from other sources, such as other devices or processes, third party sources, and so on.

The resource allocator 112 may manage or allocate power resources using one or more resource allocation algorithms. The resource allocation algorithm may be any suitable algorithm, for example max sum rate or proportional fairness algorithms, water filling, round robin queuing, or any number of simple heuristic methods and may involve optimization performed by one or more optimizers 128. For example, resource allocator 112 may use a machine learning model in the resource allocation algorithm. The system may include a model trainer for training a machine learning (ML) model, for example a reinforcement learning (RL) model, using training data, which may include any suitable information including historical data. A resource allocation algorithm may be based on, or implement, one or more allocation policies, which may have one or more considerations such as technical considerations, financial considerations, social considerations, environmental considerations, tax considerations, and so on. Resource allocator 112 may allocate the power that is available during a given time window based on the inputs received, which may include load classifications of the loads that have provided load demand requests. These can include load priorities, which may be used to allocate power. These may be referred to as power allocation priorities. For example, resource allocator 112 may allocate power to the loads in a descending order of relative priorities assigned to the loads and/or to load classifications assigned to the loads. For example, this could ensure that power is allocated to higher priority loads relating to emergency services (e.g. critical loads) and critical infrastructure before being allocated to loads such as swimming pool heaters (e.g. luxury loads).

A resource allocator, which may include an optimizer, may take and use as input information relating to a state of the control environment to generate power allocations for the loads. This information may generally be referred to as control environment information, which may be information that is generally associated with a control environment of the system, and may at least partly represent a state of the environment. An optimizer may have a predetermined model of the control environment and/or the optimizer may learn about the environment from historical data. A model may include or be based on, for example, information about load classifications, load types, load demand requests, power supply in the system, power demand in the system, and underlying behavioural patterns.

The allocation may be performed based on various factors, such as a number of load demand requests 118, the types or variety of load classifications, predicted peak power in the power system over a time period, existence of a predicted demand response event, and so on. For example, allocation may be stricter or limited when power demand in the power system is, or is expected to be, high or when power supply is, or is expected to be, low. Similarly, allocation may be looser or less stringent during periods when power demand in the power system is, or is expected to be, low and when power supply is, or is expected to be, high.

An optimization with respect to objective(s) is now discussed. An objective of an optimization performed by resource allocator 112 may be any suitable objective. Some example objectives that may be used by the resource allocator 112 include minimizing peak power consumption, maximizing availability of electricity consumption resources to loads, minimizing environmental impact e.g. greenhouse gas emissions, minimizing financial impact on customers, minimizing grid infrastructure strain.

In general, an optimization problem is typically defined by one or more decision variables, one or more objective functions, and optional constraints and bounds on the decision variables. Generally, each objective has its own objective function. An example of an objective function is maximizing profit by controlling the decision variables at hand. The variables of an objective function that the optimizer may modify correspond to the decision variables of the optimization problem. For computing purposes, an objective is a numerical quantity defined by an objective function, which is a mathematical function of one or more decision variables. Decision variables are controllable, numerical quantities or values that may be optimized such that the resulting value of the objective function is minimized or maximized depending on which is desired. A solution to an optimization problem consists of a numerical value decided upon, by means of optimization, for each decision variable.

An example of a set of decision variable(s) may be an amount of power that is allocated to a load for a given time period, what power factor they must operate at, and any class-specific operational configurations, for example indicating a dishwasher should use “eco mode”.

Inputs to optimizer 128 may be used to define or numerically evaluate the objective function and any constraint functions on the values of the decision variables in each iteration of optimizer 128. An additional input to the optimizer may be an initial estimate of the decision variables. The optimizer may try different values of the decision variables in each iteration, checking whether decision variable values meet all of the constraints, until all constraints are met and the optimizer considers the objective function to be minimized or maximized using the current values of the decision variables. These optimized decision variable values may be outputs of the optimizer, which may generally comprise an allocation of power to the loads.

An allocation of power to the loads generated by the resource allocator may take any suitable form. The allocation may include, for example, one or more of an identification of each load, an amount of power allocated to that load for a given time period(s), a maximum allowed power level during the given time period, an allowed power consumption shape, and so on.

Once a power allocation has been performed by resource allocator 112, information relating to the power allocation may be provided to the loads in any suitable way, for example through separate messages, broadcast messages, and so on. The information may be provided over communication links or networks 130.

An allocation of power to a load may be handled in one of several ways. For example, an allocation may be strictly enforced, meaning the load can only consume power when it is allocated power. Furthermore, in an embodiment, the system may be configured so that the load may only consume power in accordance with any specifications or restrictions of the allocation (for example on time of consumption, power level, etc.). Strict compliance may be enabled by issuing a power consumption authorization to the load, for example such that the authorization grants permission for the load to consume power. Without such permission, the system may be configured so the load may not be able to consume power. Further, an allocation may be softly enforced, meaning it is possible for the load to consume power without complying with the allocation (there could be partial compliance or no compliance at all), but there may be a penalty for the non-compliance, for example a financial penalty such as higher rates or costs, a fine, a tax, and so on, or any other form of penalty. Further, an allocation may not be enforced at all, meaning the load can consume power regardless of the allocation and there may be no penalty. However, there may be an incentive provided in association with the allocation to incentivize compliance (for example lower power cost for compliance).

For example, an allocation may be provided to the load as a recommendation and the load, or a user or device controlling the load may decide or otherwise determine whether to comply with the allocation. For instance, an allocation may be outputted to a user on a device, for example at the load 104 or on a computing device 124 associated with the load, and a user may provide input indicating a desired level of compliance. For example, a user may initiate a request to start a dishwasher clean cycle. The dishwasher may get allocated an allocation recommending a start time 2 hours later, for instance to defer its consumption of power. This allocation may be visually outputted and the user may select to either accept the allocation so the dishwasher starts in two hours (full compliance), to start the dishwasher immediately (no compliance), or possibly to start the dishwasher in 1 hour (possible partial compliance if the actual operation overlaps with the allocated time period).

FIG. 1A includes an example power consumption resource grid 150. In an embodiment, resource allocator 112 may allocate power to loads based on a resource grid. Resource allocator 112 may receive one or more load demand requests associated one or more loads. In an embodiment, load demand requests for several loads that are somehow associated, for example at a given customer, may be compiled into one load demand request before being provided to resource allocator 112. Power consumption grid 150 may include subdivisions of discrete blocks that represent a minimum amount of power consumption that can be granted to a load or consumer for a minimum duration of time. The grid may limit the allocation of power to the dimensions of such a grid. For example, if the resource grid 150 is 3 energy units tall, the resource allocator may not grant more than 3 energy units in any given time period t1, t2, . . . . A limitation of the amount of power that can be allocated during any given time period provides a mechanism to provide some control over power demand by loads in the system. In some embodiments, the dimensions may be fixed or they may change dynamically, for example based on a state of a power distribution or transmission network. As noted previously, a power allocator may allocate more power when demand is actually low or is predicted to be low.

Resource allocator 112 may allocate power to each load based on the power currently available (e.g., time point t1) and/or the power available at a later time (e.g., time points t2, t3, . . . tₙ). The resource allocator 112 may allocate power based on a number of available energy units (e1, e2, e3, . . . eₙ), where the magnitude of an energy unit may be defined in any suitable matter. Accordingly, in response to load demand requests 118, resource allocator 112 may allocate one or more energy units for each of one or more time periods for a load. Resource allocator 112 may allocate energy units based on load demand requests 118 in any suitable manner and at any suitable points in time, for example during certain time periods or at certain time points (for example every minute, two minutes, 10 minutes, 30 minutes, hour, and so on), as load demand requests 118 are received, and/or according to any suitable schedule for allocating power to loads 104 based on one or more load demand requests 118.

In the example of FIG. 1A in grid 150, resource allocator 112 generates power allocation information as follows. Resource allocator 112 allocates for time period t1 one power unit to customer 106, labeled ‘A’, one power unit to load 104, labeled ‘C’, and one power unit to load 104, labeled ‘D’. Resource allocator 112 allocates, for time period t2, one power unit to customer 108, labeled ‘B’, one power unit to load 104, labeled ‘C’, and one power unit to load 104, labeled ‘D’. Resource allocator 112 may perform a power allocation for one or more time periods into the future, as described. Resource allocator 112 may perform the allocation at regular or irregular time periods.

Some embodiments may allocate power in a similar manner as described in relation to the power consumption resource grid 150, although they may not use such a grid to do so. Thus, features and aspects of the embodiment described with reference to grid 150 may apply to other embodiments.

In some embodiments, load demand request information may be provided to resource allocator 112 in response to input to or other action, for example at load 104 or at computing device 124 or at anywhere else. For example, a user may trigger a request at a smart dishwasher to start a wash cycle, or may trigger a request to turn on a home heating system, for example via a smart thermostat or via a mobile phone 124 of the user. Load demand request information may originate or pass through computing device 124, smart meter 122, load 104, or any other suitable device. In addition or alternatively, load demand request information may not be initiated in response to user input, but instead be initiated at load 104, power meter 122, computing device 124, or elsewhere.

Moreover, it is noted that the present disclosure generally describes load demand requests, which are requests for power, originating from the loads. The present disclosure also describes the resource allocator as providing power allocation information, which indicates to the loads how power has been allocated to the loads, to the loads. These descriptions in the present disclosure are not limiting and are intended to cover scenarios where load demand requests for a load originate from devices other than the load itself. For example, a load demand request may originate from any suitable device, for example a computing device associated with a user who is associated with a load, for example a resident of a home or an operator of an industrial plant. For example, a user may use their phone to submit a request to turn on their home heating system, or an operator may use a work computer to turn make a request to power on equipment in a production line. Furthermore, this may include scenarios in which a device other than the load itself provides at least some control over power consumption and operation of a load, for example when a load is used with a smart plug or other device. This could apply to dumb loads which are generally able to exert limited or no control over consumption and operation of the load. Thus, for example, a load demand request may originate from such another device, such as a smart plug or other computing device, for example when a load is a dumb load. Similarly, power allocation information may be provided to a device other than the load itself, for example to a computing device such as a computing device associated with a user who is associated with a load, or to a smart plug or other device. Furthermore, in some embodiments, load demand requests and/or power allocations for loads that share some type of association, for example for loads located at a specific home or building or associated with one consumer, may be controlled or managed together. For example, a load demand request may comprise multiple load demand requests associated with multiple loads. For example, load demand requests for several loads may be collected and compiled into a single load demand request. For example, this may be done at a consumer level where load demand requests from different loads associated with that consumer are compiled and then provided to a resource allocator. For instance, in FIG. 1A, at residential customer 108, load demand requests from the two depicted loads 104 may be collected and compiled into a single load demand request. Similarly, power allocation information relevant to several associated loads may be obtained from the resource allocator and may be decompiled and provided to the individual loads. The management of load demand requests and/or power allocations for loads that share some type of association may be done anywhere, for example at a device located at the physical premises, such as a home or building, or remotely on a server or other computing system.

FIG. 2 is an example tree graph showing example load classifications in an example tree or hierarchy structure, where each node is a load classification, and each subsequent node provides further load classifications of the preceding load. The examples described in reference to FIG. 2 are for illustrative purposes only. Load classifications may relate to any suitable factors or features, for example to load type, geographical, region, customer type, and/or any other relevant context. Load classification information may be used by the resource allocator when allocating power to loads such that different load classifications are treated differently. Load classification information may include load priority information, so that different load classifications have different priority levels.

In FIG. 2, node level 202 may represent an aggregate load, which may represent methods of existing approaches by which power consumption is measured and billed per household or industry. For example, in which energy consumption is calculated as an aggregate of all loads within a time period without any further classification or distinction.

Node level 204 may divide the aggregate load classification into user type, for example residential and industrial. Other user types may be used.

Node level 206 may divide the load classifications at 204 based on categories of relative importance, which may be determined in any way. For example, load classifications may distinguish what may be considered to be essential loads from non-essential loads. For a residential user, this distinction may be represented by essential loads and premium/luxury loads. For an industrial user, loads may be distinguished by industrial customer type. For example, Class A customers may have a service level agreement (SLA) or other arrangement that requires a utility to allocate a minimum amount of power at certain times and/or in certain contexts, whereas a Class B customer may not be governed by minimum standards set by, for example an SLA. Similarly, emergency services may be distinguished from other load classifications at 206.

Node level 208 may divide the load classifications at 206 into additional categories representing further load classifications. For example, essential loads may be distinguished as heating/cooling, EV charging, and building-related loads. Premium or luxury loads may be distinguished by type, for example, a pool heater or hot tub. For industrial and/or commercial users, the loads may be further distinguished by operation, location, and so on, for example, a fleet depot, large factory, and/or mining site.

Node level 210 may divide the load classifications at 208 into further load classifications. For example, a residential building load may be further subdivided by lights, appliances, and other loads. An industrial/commercial fleet depot may be further subdivided into a building load and one or more EV charging loads.

The load classifications and the tree structure of FIG. 2 are merely some examples. Other classifications are possible, including for-profit and non-for-profit.

Load classifications may be fixed or dynamic. Load classifications may be determined by a variety of means and may be further determined in the context of political, socioeconomic, and/or environmental factors. For example, an EV may be considered an essential load for a household that only has one vehicle, whereas an EV that is a second EV of two EVs in a household may be considered a premium load. In some geographical locations, heating may be an essential load, whereas other geographical locations may consider heating as a non-essential load. In some embodiments, emergency services and/or government may be considered a user type separate from residential and/or industrial/commercial users.

As noted above, a load profile may include information relating to the load such as load priority (for example so loads can have relative priorities for power allocation), load shape (for example typical or requested power consumption as a function of time), load deferability (for example degree to which consumption may be deferred in time), load curtailability (for example degree to which consumption may be curtailed, meaning reduced), and so on.

Load profile information 116 may have load shape information. A load shape may be the requested power consumption as a function of time. For example, an appliance, such as a washing machine or dishwasher, may have periods of higher and lower consumption based on the time/stage of a particular cycle.

In some embodiments, a load shape may have a minimum and/or maximum energy envelope. The energy envelope may account for potential unpredictability of the actual energy consumption of a load when power has been allocated. Such unpredictability may stem from a variety of factors, which may be intrinsic and/or extrinsic to the load. Intrinsic variability may be related to, for example, operating conditions, for example a washing machine detects a heavier load and runs longer, or to a malfunction. Extrinsic variability may be related to external factors, for example damage, weather, a demand response event, and so on. Other factors leading to variability and unpredictability of power consumption of a load are possible.

Load profile information 116 may include load shape optionality or load shape preferences. Some load classifications may have a family of load shapes that may represent different use cases of the load. For example, a dishwasher may have different cycles with different load shapes, for example a deep clean versus an “eco” mode, in which different factors related to energy consumption may be toggled or varied. For example, a deep clean cycle of a dishwasher may prioritize performance over energy efficiency and have a shape requiring a greater net power over time, whereas an “eco mode” wash may have the opposite priorities. In some embodiments, the load demand request 118 may specify a preferred shape and/or one or more optional shapes. When one or more optional shapes are included in the load demand request 118, the system 100 may allocate a load shape or forbid a load shape as required by the system 100 at a given time or in anticipation of a predicted demand response event.

Load profile information 116 may include deferability information. Deferability may refer to the ability of a load to consume energy at a delayed time or, for example, to consume power in intervals separated by periods of no power use. Deferability may refer to the time sensitivity of the load. For example, a critical load or another classification may be configured to have no available deferability. Examples include critical infrastructure and certain loads that are expected to work on demand, such as stove. Other loads may have deferability, for example a dish washer or clothes washer may be configured to operate at any times in a defined time window (e.g. overnight).

Load profile information 116 may have curtailability information. Curtailability may generally refer to an ability of a load to be curtailed. A load that has curtailability may have its consumption scaled down (or up). For example, a load shape of a load may be adjusted at one or more (or all) points in time to consume greater or less power than the default and/or requested load shape. A mere example of a load that may possibly be curtailed is an EV. For example, an EV may be configured to be charged in any way overnight so long as the EV is fully charged by morning. Charging could involve a short, quick charging session, or it could involve a longer slow charging session, and so on. A load that does not have curtailability may, for example, only be on or off (for example a kettle), or otherwise be fixed.

Load profile information 116 may include geographic information. A demand capacity of a power system, for example a grid, may vary depending on the location of the network. Numerous grid attributes may collectively determine capacity limitations, such as rated conductor ampacities for primary and backup feeders, the power ratings of the various transformers at different levels of the network, and circuit recloser fault current ratings. Thus, the resource allocator may optimize and allocated for groups of load demand requests associated with a particular geographic region or associated with a particular part of a network in a power system (e.g. a certain portion of a local distribution network). This may be done to limit demand on a specific part of a distribution network. In addition, metadata associated with of a load may provide information relating to a location of the load, for example a fixed geographic location (for example a dishwasher) or changing locations (for example an EV).

Load profile information 116 may include security preference information. For example, load demand requests 118 may be anonymized to protect the privacy of customers and/or as a means to reduce discrimination and/or denial of service to particular individuals.

Load profile information 116 may have agreement information, for example relating to conditions related to a service level agreement (SLA). An SLA may be between a customer and a utility or any other party relevant to the distribution of power. For example, stemming from an SLA, load profile information 116 may have predetermined quality and/or quantity of service guarantees that the system 100 may be legally obliged to meet. Such conditions may have override conditions and/or prioritization with respect to other loads (for example emergency services), as stipulated by the SLA, for example.

The examples of load profile information 116 are not exhaustive and may include other parameters. Features of load profile information 116 may be mutually exclusive or may relate to one another, as the case may be. Load profile information 116 may be related to load classification information 114. Load profile information 116 may be used to infer load classification information 114, and/or load classification information 114 may be used to infer load profile information 116. Load profile information 116 may be mutually exclusive to load classification information 114.

In some embodiments, load profile information 116 may be viewed, selected, and/or toggled via a user interface, for example at load 104 or at computing device 124. In other embodiments, load profile information may not be customer facing and/or may be intrinsic to the load as it is configured.

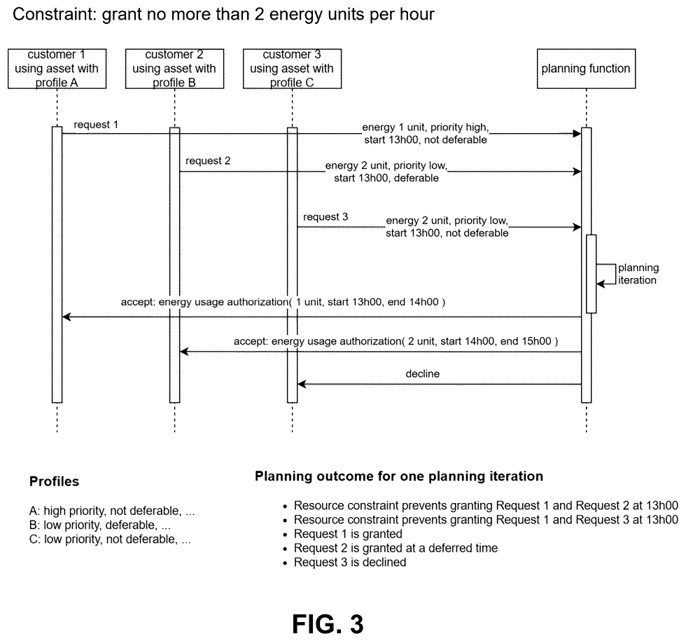

FIG. 3 is a message sequence diagram showing an example embodiment of allocating power allocation based on load profile information and/or load classification information. The example has a resource constraint that no more than two energy units may be allocated and authorized at the same time, and time points are 1 hour long. Thus, under the constraints, no more than 2 energy units may be granted per hour.

Customers 1, 2, and 3 submits load demand requests, request 1, request 2, and request 3, respectively. Request 1 requests 1 energy unit at 13h00 and relates to an asset or load with load profile A, which indicates a high priority, and not deferable. Request 2 requests 2 energy units needed at 13h00 and relates to an asset or load with load profile B, which indicates low priority, and deferable. Request 3 requests 2 energy units needed at 13h00 and relates to an asset or load with load profile C, which indicates low priority and not deferable.

At the planning function, a resource allocator allocates power to the loads based on the load demand requests, associated load profiles information, and on applicable constraints (in this example, allocate no more than 2 energy units per hour). The resource allocator allocates request 1, allocates power in relation to request 2 but at a deferred time, and allocates no power in relation to request 3, thereby declining request 3. The power allocation is provided to customers 1, 2, and 3.

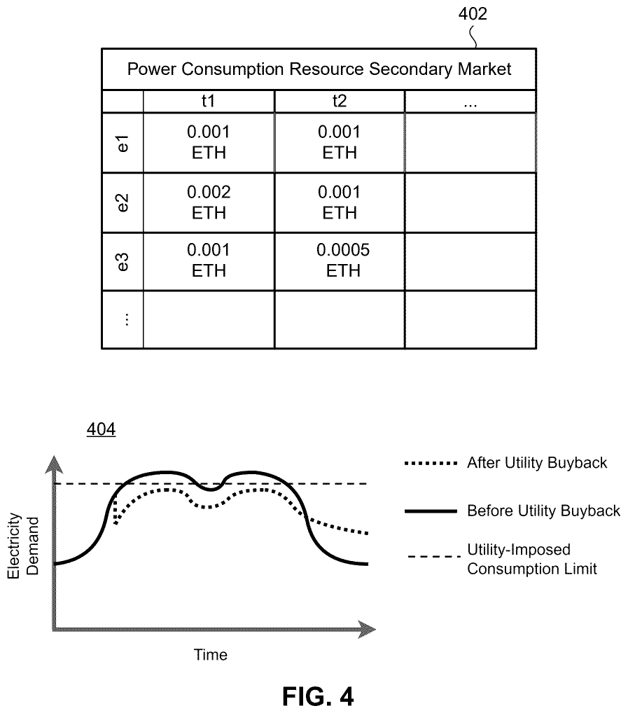

FIG. 4 shows an example of a power resource secondary market grid 402 and associated graph 404 related to a secondary market for buying and selling power resources, which may include allocations or authorizations of power. In a secondary market, users may be able to buy and/or sell their allocated power resources. Similarly, a power system, such as a local utility, may be able to buy power resources, for example to provide additional curtailment of demand when needed. In grid 402, power resources are represented in a grid that can be purchased at the indicated price. The prices are in ETH, which is the native currency used on the Etherium blockchain. Power resources need not be traded in any particular currency, although blockchains may help implement a secondary market for power resources. Rows e1, e2 and e3 represent single atomic units of power resources that may be purchased, whereas the t1 and t2 columns indicate the time that they may be purchased at or for. The cells in grid 402 indicate the prices for each atomic power unit, which may be set by the sellers of the power resources that compete on the open market for sales. Once purchased, the new owner may consume the purchased power resources without having to be allocated that power from a resource allocator. In the example, if 1 unit of power is needed for 2 units of time, the price would be 0.0015 ETH, which is the sum of the two cheapest power units available at t1 and t2 in grid 402. Similarly, if 3 units of power is need for 2 units of time, the price would be 0.0065 ETH.

Graph 404 represents an example way that a power system, such as an electricity distribution utility, may use a secondary market to their advantage by buying allowed power resources, thus possibly resulting in a deterministic downwards shift in load to curtail peak demand, for example when the power system is at risk of surpassing infrastructure thresholds.

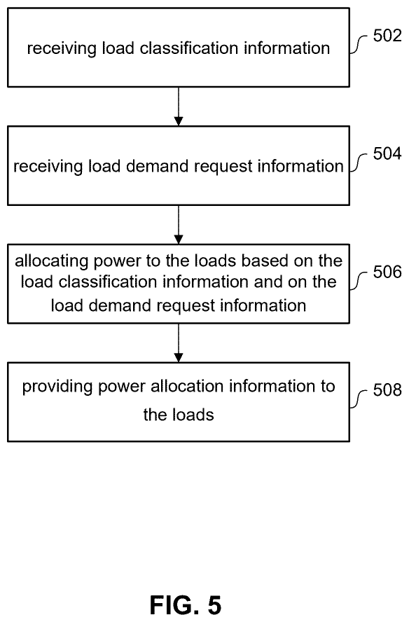

FIG. 5 is a process flow diagram showing some example operation or steps of a computer-implemented method for providing control in relation to a power system for providing power to a plurality of electric loads according to an embodiment.

At block 502, the process may comprise receiving load classification information. The load classification information may include a load classification associated with each of the plurality of loads, wherein there are multiple different load classifications.

At block 504, the process may comprise receiving load demand request information. The load demand request information may include multiple load demand requests for power, wherein each request is associated with at least one load.

At block 506, the process may comprise allocating power to the loads based on the load classification information and on the load demand request information.

At block 508, the process may comprise providing power allocation information to the loads. The power allocation information may be based on the allocated power.

The process according to FIG. 5 may be repeated, as already described herein.

Systems, methods, and devices according to the present disclosure may be beneficial in a variety of applications. For example, load classification and related systems, methods, and devices may be used to support government policies aimed at taxing and/or subsidizing electricity loads to support socioeconomic initiatives. For example, luxury loads may be taxed to subsidize essential loads for low income households. For example, consider a large EV versus baseboard heating in a cold climate. As another example, a “carbon score” system may be associated with power customers based on, for example power consumption, use of energy efficient loads, choosing an electrified load over a fossil fuel based service/load, etc. As another example, alternative revenue streams to “gas” tax or carbon tax may be developed through the taxation of loads, such as electric vehicle loads.

As another example, a pricing mechanism may be developed for power system operators (for example the Independent Electricity System Operator (IESO) in Ontario, the California Independent System Operator (CAISO)) to price power for customers (namely, industrial customers) to drive grid-shape behaviour. For example, in lieu of having universal fees payable by industrial power customers in proportion to their consumption at times of peak system demand (for example global adjustment fees in the IESO-regulated market), system operators may charge extra for nonessential, deferrable and/or curtailable loads. Similarly, industrial consumers may be exempt from auxiliary fees, such as global adjustment, for loads that are serving “mission critical” purposes, for example operating an electric bus fleet to assure the availability of public transportation in a community.

As another example, high value, high demand operations may be levied to fund distribution infrastructure expansion for their accommodation, for example graphical processing unit (GPU)/application specific integrated chip (ASIC) farms that train large machine learning models or mine cryptocurrency.

Systems, methods, and devices according to the present disclosure may be used to influence or change consumer habits with respect to power consumption in conjunction with policy and pricing strategies implemented by utilities, power system operators, and/or governments.

In some embodiments, algorithms, techniques, and/or approaches according to the present disclosure may be performed or based on artificial intelligence (AI) algorithms, techniques, and/or approaches. This includes but is not limited to controllers, optimizers, predictors, and other computing devices and systems or components according to the present disclosure, as well as power allocation systems and resource allocators.

In some embodiments, the AI algorithms and techniques may include machine learning techniques.

Machine Learning (ML) may be used in systems and methods according to the present disclosure, including power allocation systems and resource allocators. Machine learning systems may be used in the allocation of power to loads according to the present disclosure, for example in an optimizer for use in allocating power. Machine learning systems may to predict or estimate information, for example power demand in a power system, power supply, abilities to curtail or defer power consumption of loads, future power generation or resource availability, EV owner behaviour, and so on. Predictions may be used in power allocation, for example in relation to various objectives such as power supply-demand balancing, peak shifting or shaving, cost minimization, efficiency maximization, or optimal use of local renewable energy. Further, predictors and/or optimizers, and the training thereof, may also use or be based on machine learning techniques.

A machine learning algorithm or system may receive data, for example historical data, streaming controllable asset data, environmental data, and/or third party data, and, using one or more suitable machine learning algorithms, may generate one or more datasets. Example types of machine learning algorithms include but are not limited to supervised learning algorithms, unsupervised learning algorithms, reinforcement learning algorithms, semi-supervised learning algorithms (e.g. where both labeled and unlabeled data is used), regression algorithms (for example logistic regression, linear regression, and so forth), regularization algorithms (for example least-angle regression, ridge regression, and so forth), artificial neural network algorithms, instance based algorithms (for example locally weighted learning, learning vector quantization, and so forth), Bayesian algorithms, decision tree algorithms, clustering algorithms, and so forth. Further, other machine learning algorithms may be used additionally or alternatively. In some embodiments, a machine learning algorithm or system may analyze data to identify patterns and/or sequences of activity, and so forth, to generate one or more datasets.

A system, such as a power allocation system, may comprise one or more allocation policies. The allocation policies of the system may be based on trained machine learning based systems. In this sense, an allocation policy may be part of a control agent. A control agent observes its environment, herein referred to a control environment, and takes action based on its observations, or percepts, of the control environment. The taking of action is referred to as controlling the system. Depending on the state of the environment, taking action may involve taking no action at all, for example if there has been little or no change in the state since the last time the agent took action. Thus, doing nothing is a valid action in a set of actions in the action space of the controller. In an embodiment, the present systems and methods may exploit the flexibility of various loads and possibly other assets to achieve improved performance of the system.

In an embodiment, online machine learning may be employed. Online machine learning is a technique of machine learning where data becomes available sequentially over time. The data is utilized to update a predictor for future data at each step in time (e.g. time slot). This approach of online machine learning may be contrasted to approaches that use batch learning wherein learning performed on an entire or subset of training data set. Online machine learning is sometimes useful where the data varies significantly over time, such as in power or energy pricing, commodity pricing, and stock markets. Further, online machine learning may be helpful when it is not practical or possible to train the agent over the entire or subset of data set.

In embodiments according to the present disclosure, training of a machine learning system, such as a predictor or forecaster or optimizer, may be based on offline learning and/or online learning where the streaming real-time data may be combined with at least some data, for example from a database, to train the machine learning system in real-time or near real-time. Over time, a machine learning system may be retrained, for example with newer or different training data.

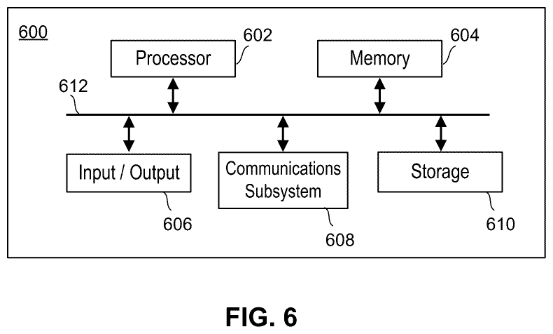

FIG. 6 is a block diagram of an example computerized device or system 600 that may be used in implementing one or more aspects or components of an embodiment according to the present disclosure. For example, system 600 may be used to implement a computing device or system, for example a power allocation system, a resource allocator, and so on. Thus, one or more systems 600 may be configured to implement one or more portions of the systems or apparatuses or methods according to the present disclosure.

Computerized system 600 may comprise one or more of classic, analog, electronic, digital, and quantum computing technologies. Computerized system 600 may include one or more of a computer processor device 602, memory 604, a mass storage device 610, an input/output (I/O) interface 606, and a communications subsystem 608. A computer processor device may be any suitable device(s), and encompasses various devices, systems, and apparatus for processing data and instructions. These include, as examples only, one or more of a hardware processor, a digital processor, an electronic processor, a quantum processor, a programmable processor, a computer, a system on a chip, and special purpose logic circuitry such as an ASIC (application-specific integrated circuit) and/or FPGA (field programmable gate array). In addition, system 600 may include hardware dedicated to one or more specific purposes, such as a graphics processing unit (GPU), or a tensor processing unit (TPU) or other artificial intelligence accelerator ASIC, for example for machine learning (ML).

Memory 604 may be configured to store computer readable instructions, that when executed by processor 602, cause the performance of operations, including operations in accordance with the present disclosure.

One or more of the components or subsystems of computerized system 600 may be interconnected by way of one or more buses 612 or in any other suitable manner.

The bus 612 may be one or more of any type of several bus architectures including a memory bus, storage bus, memory controller bus, peripheral bus, or the like. The processor 602 may comprise any type of electronic data processor. The memory 604 may comprise any type of system memory such as dynamic random access memory (DRAM), static random access memory (SRAM), synchronous DRAM (SDRAM), read-only memory (ROM), a combination thereof, or the like. In an embodiment, the memory may include ROM for use at boot-up, and DRAM for program and data storage for use while executing programs.

The storage device 610 may comprise any type of storage device configured to store data, programs, and other information and to make the data, programs, and other information accessible via the bus 612. The storage device may be adapted to store one or more databases and/or data repositories, each of which is generally an organized collection of data or other information stored and accessed electronically via a computer. The term database or repository may thus refer to a storage device comprising a database. The mass storage device 610 may comprise one or more of a solid state drive, hard disk drive, a magnetic disk drive, an optical disk drive, or the like. In some embodiments, data, programs, or other information may be stored remotely, for example in the cloud. Computerized system 600 may send or receive information to the remote storage in any suitable way, including via communications subsystem 608 over a network or other data communication medium.

The I/O interface 606 may provide interfaces for enabling wired and/or wireless communications between computerized system 600 and one or more other devices or systems. Furthermore, additional or fewer interfaces may be utilized. For example, one or more serial interfaces such as Universal Serial Bus (USB) (not shown) may be provided. Further, system 600 may comprise or be communicatively connectable to a display device, and/or speaker device, a microphone device, an input device such as a keyboard, button, pointer, mouse, touch screen display, microphone, camera, scanner, or any other type of input device.

Computerized system 600 may be used to configure, operate, control, monitor, sense, and/or adjust devices, systems, and/or methods according to the present disclosure.

A communications subsystem 608 may be provided for one or both of transmitting and receiving signals over any form or medium of digital data communication, including a communication network. Examples of communication networks include a local area network (LAN), a wide area network (WAN), telecommunications network, cellular network, an inter-network such as the Internet, and peer-to-peer networks such as ad hoc peer-to-peer networks. Communications subsystem 608 may include any component or collection of components for enabling communications over one or more wired and wireless interfaces. These interfaces may include but are not limited to USB, Ethernet (e.g. IEEE 802.3), high-definition multimedia interface (HDMI), Firewire™ (e.g. IEEE 1394), Thunderbolt™, WiFi™ (e.g. IEEE 802.11), WiMAX (e.g. IEEE 802.16), Bluetooth™, or Near-field communications (NFC), as well as General Packet Radio Service (GPRS), Universal Mobile Telecommunications System (UMTS), Long-Term Evolution (LTE), LTE-A, 5G NR (New Radio), satellite communication protocols, and dedicated short range communication (DSRC). Communication subsystem 608 may include one or more ports or other components (not shown) for one or more wired connections. Additionally or alternatively, communication subsystem 608 may include one or more transmitters, receivers, and/or antenna elements (none of which are shown). Further, system 600 may comprise clients and servers.

Computerized system 600 of FIG. 9 is merely an example and is not meant to be limiting. Various embodiments may utilize some or all of the components shown or described. Some embodiments may use other components not shown or described but known to persons skilled in the art.

Logical operations of the various embodiments according to the present disclosure may be implemented as (i) a sequence of computer implemented steps, procedures, or operations running on a programmable circuit in a computer, (ii) a sequence of computer implemented operations, procedures, or steps running on a specific-use programmable circuit; and/or (iii) interconnected machine modules or program engines within the programmable circuits. The computerized device or system 600 of FIG. 6 may practice all or part of the recited methods or operations, may be a part of systems according to the present disclosure, and/or may operate according to instructions in computer-readable storage media. Such logical operations may be implemented as modules configured to control a computer processor, such as processor 602, to perform particular functions according to the programming of the module. In other words, a computer processor, such as processor 602, may execute the instructions, steps, or operations according to the present disclosure, including of the one or more of the blocks or modules. For example, one or more of the modules or blocks or operations and so on according to the present disclosure may be configured to control processor 602. For example, one or more of the modules or blocks or operations and so on may include but are not limited to, for example, a power allocation system, a resource allocator, and so on. At least some of these blocks or modules may be stored on storage device 610 and loaded into memory 604 at runtime or may be stored in other computer-readable memory locations.

The term module used herein may refer to a software module, a hardware module, or a module comprising both software and hardware. Generally, software includes computer executable instructions, and possibly also data, and hardware refers to physical computer hardware.

The term ‘data’ generally refers to raw or unorganized facts whereas ‘information’ generally refers to processed or organized data. However, the terms are generally used synonymously herein unless indicated otherwise.

Embodiments and operations according to the present disclosure may be implemented in digital electronic circuitry, and/or in computer software, firmware, and/or hardware, including structures according to this disclosure and their structural equivalents. Embodiments and operations according to the present disclosure may be implemented as one or more computer programs, for example one or more modules of computer program instructions, stored on or in computer storage media for execution by, or to control the operation of, one or more computer processing devices such as a processor. Operations according to the present disclosure may be implemented as operations performed by one or more processing devices on data stored on one or more computer-readable storage devices or media, and/or received from other sources.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not necessarily provided as to whether the embodiments described herein are implemented as a computer software, computer hardware, electronic hardware, or a combination thereof.

In at least some embodiments, one or more aspects or components may be implemented by one or more special-purpose computing devices. The special-purpose computing devices may be any suitable type of computing device, including desktop computers, portable computers, handheld computing devices, networking devices, or any other computing device that comprises hardwired and/or program logic to implement operations and features according to the present disclosure.

Embodiments of the disclosure may be represented as a computer program product stored in a machine-readable medium (also referred to as a computer-readable medium, a processor-readable medium, or a computer usable medium having a computer-readable program code embodied therein). The machine-readable medium may be any suitable tangible, non-transitory medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations may also be stored on the machine-readable medium. The instructions stored on the machine-readable medium may be executed by a processor or other suitable processing device, and may interface with circuitry to perform the described tasks.

The structure, features, accessories, and/or alternatives of embodiments described and/or shown herein, including one or more aspects thereof, are intended to apply generally to all of the teachings of the present disclosure, including to all of the embodiments described and illustrated herein, insofar as they are compatible. Thus, the present disclosure includes embodiments having any combination or permutation of features of embodiments or aspects herein described.

In addition, the steps and the ordering of the steps of methods and data flows described and/or illustrated herein are not meant to be limiting. Methods and data flows comprising different steps, different number of steps, and/or different ordering of steps are also contemplated. Furthermore, although some steps are shown as being performed consecutively or concurrently, in other embodiments these steps may be performed concurrently or consecutively, respectively.

For simplicity and clarity of illustration, reference numerals may have been repeated among the figures to indicate corresponding or analogous elements. Numerous details have been set forth to provide an understanding of the embodiments described herein. The embodiments may be practiced without these details. In other instances, well-known methods, procedures, and components have not been described in detail to avoid obscuring the embodiments described.

The embodiments according to the present disclosure are intended to be examples only. Alterations, modifications and variations may be effected to the particular embodiments by those of skill in the art without departing from the scope, which is defined solely by the claims appended hereto.

The terms “a” or “an” are generally used to mean one or more than one. Furthermore, the term “or” is used in a non-exclusive manner, meaning that “A or B” includes “A but not B,” “B but not A,” and “both A and B” unless otherwise indicated. In addition, the terms “first,” “second,” and “third,” and so on, are used only as labels for descriptive purposes, and are not intended to impose numerical requirements or any specific ordering on their objects.

1. A system, comprising:
a computer-readable storage medium having executable instructions; and
one or more computer processors configured to execute the instructions to provide control in relation to a power system for allocating power to a plurality of electric loads, the instructions to:
receive load classification information, the load classification information including a load classification associated with each of the plurality of loads, wherein there are multiple different load classifications;
receive load demand request information, the load demand request information including multiple load demand requests for power, wherein each request is associated with at least one load;
allocate power to the loads based on the load classification information and on the load demand request information; and
provide power allocation information to the loads, the power allocation information based on the allocated power.

2. The system of claim 1, the instructions further to:
provide power consumption authorization information to the loads, the power consumption authorization information based on the allocated power to the loads and granting permission to the loads to consume power as allocated to the loads.

3. The system of claim 1, wherein at least one load is assigned a higher power allocation priority relative to another load, and wherein the allocating power to the loads is also based on power allocation priority information assigned to at least some of the loads.

4. The system of claim 1, wherein at least some of the load demand requests are each associated with load profile information, wherein the load profile information relates to a nature of the request for power associated with the load demand request, and wherein the allocating power to the loads is also based on the load profile information.

5. The system of claim 4, wherein load profile information associated with a load demand request comprises information relating to power consumption shape, wherein power consumption shape relates to power level and temporal information.

6. The system of claim 4, wherein load profile information associated with a load demand request comprises information relating to load deferability, wherein load deferability relates to an availability for delaying in time consumption of the power associated with the load demand request.

7. The system of claim 4, wherein load profile information associated with a load demand request comprises information relating to load curtailability, wherein load curtailability relates to an availability for curtailment of the power associated with the load demand request.

8. The system of claim 1, wherein allocating power to the loads comprises allocating power to a load wherein the allocation to the load includes a power consumption shape limitation.

9. The system of claim 1, wherein the instructions are further to determine a level of compliance by a load to power that has been allocated to the load, and initiating a compliance action based on the determined level of compliance.

10. A method comprising:
at one or more electronic devices each having one or more processors and computer-readable memory, to provide control in relation to a power system for allocating power to a plurality of electric loads:
receiving load classification information, the load classification information including a load classification associated with each of the plurality of loads, wherein there are multiple different load classifications;
receiving load demand request information, the load demand request information including multiple load demand requests for power, wherein each request is associated with at least one load;
allocating power to the loads based on the load classification information and on the load demand request information; and
providing power allocation information to the loads, the power allocation information based on the allocated power.

11. The method of claim 10, further comprising:
providing power consumption authorization information to the loads, the power consumption authorization information based on the allocated power to the loads and granting permission to the loads to consume power as allocated to the loads.

12. The method of claim 10, wherein at least one load is assigned a higher power allocation priority relative to another load, and wherein the allocating power to the loads is also based on power allocation priority information assigned to at least some of the loads.

13. The method of claim 10, wherein at least some of the load demand requests are each associated with load profile information, wherein the load profile information relates to a nature of the request for power associated with the load demand request, and wherein the allocating power to the loads is also based on the load profile information.

14. The method of claim 13, wherein load profile information associated with a load demand request comprises information relating to power consumption shape, wherein power consumption shape relates to power level and temporal information.

15. The method of claim 13, wherein load profile information associated with a load demand request comprises information relating to load deferability, wherein load deferability relates to an availability for delaying in time consumption of the power associated with the load demand request.

16. The method of claim 13, wherein load profile information associated with a load demand request comprises information relating to load curtailability, wherein load curtailability relates to an availability for curtailment of the power associated with the load demand request.

17. The method of claim 10, wherein allocating power to the loads comprises allocating power to a load wherein the allocation to the load includes a power consumption shape limitation.

18. The method of claim 10, further comprising:
determining a level of compliance by a load to power that has been allocated to the load, and
initiating a compliance action based on the determined level of compliance.

19. A non-transitory computer-readable medium comprising having computer-readable instructions stored thereon, the computer-readable instructions executable by at least one processor to cause the performance of operations relating to providing control in relation to a power system for allocating power to a plurality of electric loads, the operations comprising:
receiving load classification information, the load classification information including a load classification associated with each of the plurality of loads, wherein there are multiple different load classifications;
receiving load demand request information, the load demand request information including multiple load demand requests for power, wherein each request is associated with at least one load;
allocating power to the loads based on the load classification information and on the load demand request information; and
providing power allocation information to the loads, the power allocation information based on the allocated power.

20. The non-transitory computer-readable medium of claim 19, the operations further comprising:
providing power consumption authorization information to the loads, the power consumption authorization information based on the allocated power to the loads and granting permission to the loads to consume power as allocated to the loads.
